(19) United States
(12) Patent Application Publication
(10) Pub. No.: US 2015/0161236 A1
(43) Pub. Date: Jun. 11, 2015

(54) RECORDING CONTEXT FOR CONDUCTING SEARCHES

(71) Applicant: Lenovo (Singapore) Pte. Ltd., Singapore (SG)

(72) Inventors: Suzanne Marion Beaumont, Wake Forest, NC (US); Rod D. Waltermann, Rougemont, NC (US); Russell Speight VanBlon, Raleigh, NC (US); Jonathan Gaither Knox, Morrisville, NC (US); Peter Hamilton Wetsel, Raleigh, NC (US); Hermann Franz Bergmeier, Chapel Hill, NC (US)

(73) Assignee: Lenovo (Singapore) Pte. Ltd., Singapore (SG)

(21) Appl. No.: 14/098,080

(22) Filed: Dec. 5, 2013

(51) Int. Cl. G06F 17/30

(52) U.S. Cl. CPC G06F 17/30607; G06F 17/30312; G06F 17/30675; G06F 17/30289

(57) ABSTRACT

An embodiment provides a method, including: collecting, using a first user device, ephemeral data associated with a user object event; collecting, using at least one processor, user object event data; creating, using at least one processor, an association between the ephemeral data and the user object event data; and storing, in a memory, the association in a data structure accessible to a device application. Other aspects are described and claimed.

### BACKGROUND

Information handling devices (“devices”), for example laptop computers, tablets, smart phones, desktop computers, smart TVs, navigation devices, automobile consoles, etc., may be used to process search inputs, e.g., speech or text inputs received searching for a file, a destination, etc. For example, a user inputs search term(s), e.g., via keyboard input, speech input, etc., into an application that identifies data of interest to the user based on the searched term(s). An example search includes searching for files, e.g., pictures, documents, videos, etc., of the user in a file search application.

### BRIEF SUMMARY

In summary, one aspect provides a method, comprising: collecting, using a first user device, ephemeral data associated with a user object event; collecting, using at least one processor, user object event data; creating, using at least one processor, an association between the ephemeral data and the user object event data; and storing, in a memory, the association in a data structure accessible to a device application.

Another aspect provides an information handling device, comprising: one or more sensors that collect ephemeral data; a processor; and a memory device that stores instructions executable by the processor to: collect ephemeral data associated with a user object event; collect user object event data; create an association between the ephemeral data and the user object event data; and store the association in a data structure accessible to a device application.

Another aspect provides a product, comprising: a storage device having code stored therewith, the code comprising: code that collects, using a first user device, ephemeral data associated with a user object event; code that collects, using at least one processor, user object event data; code that creates, using at least one processor, an association between the ephemeral data and the user object event data; and code that stores, in a memory, the association in a data structure accessible to a device application.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of an information handling device.

FIG. 3 illustrates an example method of recording context for conducting searches.

FIG. 4 illustrates an example method of using context for conducting searches.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

When searching for a file (e.g., picture, document, music file, etc.), a user tends to remember things based not only on the properties of the object itself, e.g., title, content, etc., but also based on the context associated with the object. For example, users tend to associate sensed information with object related events (e.g., object creation, storage, retrieval, editing, transmission, etc.). That is, users tend to remember what they were doing or what the environment was like when they were using/interacting with the object. As such, when users search for something, it is often through these alternative associations that users find what they are looking for.

Current search applications base their searching on the properties of the object, i.e., the search target. However, it happens that those object properties (e.g., file name, date/time when saved, etc.) are often not known to the users, not remembered by the users, or misstated by the users when inputting search terms. In these cases, searching becomes an inaccurate and/or tedious endeavor, that may not yield any relevant results.

Accordingly, an embodiment collects ephemeral data to provide context information that may be used to augment searching. By recording as much information as possible that may be used to provide or infer the current context, rich and natural associations to user content (herein “user objects”) can be made. As will be further appreciated below, contextual data may be derived from a variety of sources, e.g., sensor inputs, hardware connection information, virtual connection information, device state information, etc. This collection of data can be described as real-time or ephemeral data, that is, data or information that is known in the moment, but not normally discerned at a later time. For example, an embodiment utilizes ephemeral data obtained, e.g., via sensors collecting GPS coordinates, audio data, biometric data, device state data, etc., and makes this ephemeral data available to assist or augment searching.

By recording the ephemeral data set in association with file, process, application and/or hardware connection events, it is possible to rewind and reconstruct a point in time to accurately represent the context associated with the object event, e.g., object creation, object access, etc. If this contextual information is married with forensic type information, like meta-data, keyword extraction, and so on, then the associations to a user's content are extremely rich and in fact support low and high order correlations useful in various searching applications. For example, a user could search for a file based not only on surmised keywords, but, using an embodiment, also based on where he or she was when a document was read or edited, or who the document was shared with during a meeting, or even the temperature of the room when he or she accessed the document, etc.

The illustrated example embodiments will be best understood by reference to the figures. The following description is intended only by way of example, and simply illustrates certain example embodiments.

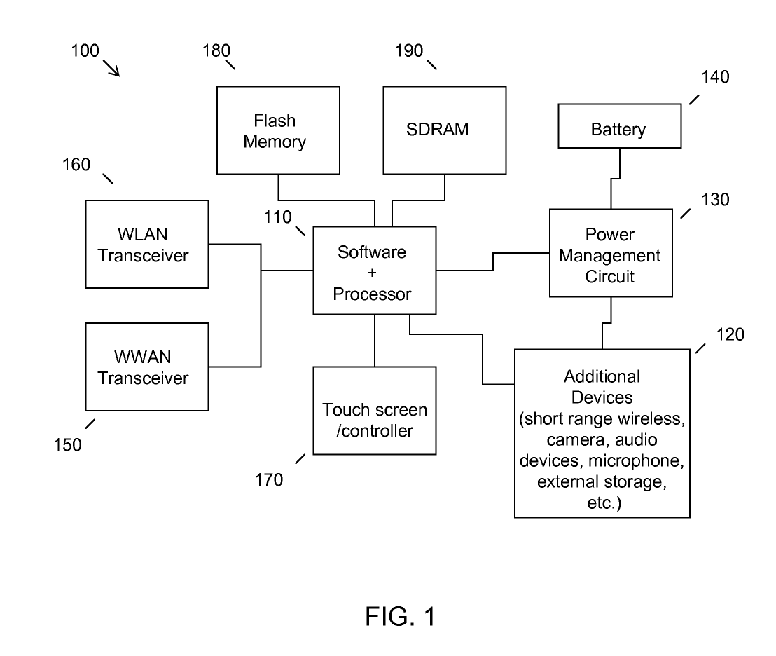

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, one of the additional devices 120 is commonly a microphone, which may include physical elements that transforms sound waves into an electrical audio signal. Commonly, system 100 will include a touch screen 170 for data input and display/rendering. System 100 also typically includes various memory devices, for example flash memory 180 and SDRAM 190.

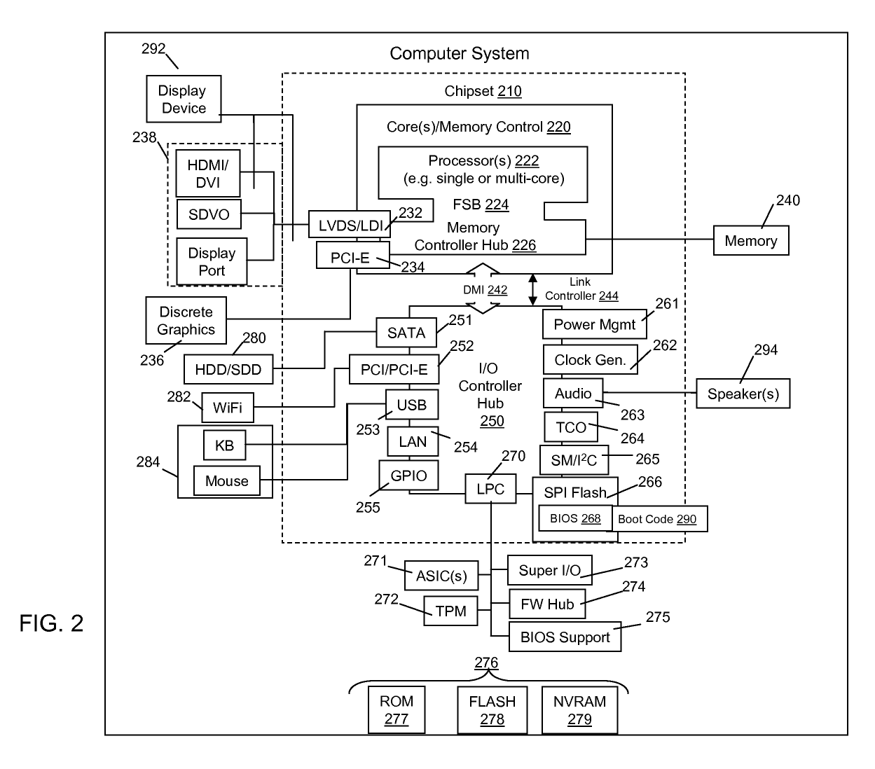

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices that collect ephemeral data for use in contextual searching, as further described herein. Examples of the real-time ephemeral data that may be collected, and the sensors or other hardware devices or sources used in the collection, include but are not necessarily limited to environmental data (e.g., temperature, humidity, atmospheric pressure, wind speed, wind direction, etc., collected via, e.g., sensors such as thermometers, barometers, and/or access to applications containing such information derived from a third party), biometric data (e.g., human presence, human proximity, touch, facial recognition, eye tracking, gaze detection, etc., e.g., collected, e.g., via biometric devices such as a fingerprint reader, camera(s) or the like), light data (e.g., ambient, infrared, collected, e.g., via single or multi-dimensional camera(s)), sound data (e.g., acoustic record derived from microphone(s), etc), device orientation data (e.g., orientation data collected via a single or multi-dimensional compass, via a single or multi-dimensional inclinometer, etc.), device motion data (e.g., collected via a single or multi-dimensional accelerometer, via a single or multi-dimensional gyrometer, etc.), location data (e.g., collected via a global positioning satellite system, via a system collecting static, broadcast and/or dead reckoning data, etc.), scan data (e.g., triangulation data, barcode data, radio frequency identification data RFID, quick response (QR) code data, near field communication (NFC) data, etc., e.g., collected via components configured to collect the same, etc.), time data (e.g., real-time clock data, alarm data, etc.), hardware connection data (e.g., USB connection data, FIREWIRE cable connection data, high definition multimedia interface (HDMI) data, other port data, etc.), virtual connection data (e.g., web pages open, RSS feeds active, streams received, etc.), and device state data (e.g., open applications, power state, etc.).

While such ephemeral data may be collected, e.g., using a plurality of sensors, it may not be useful unless analyzed and converted into another form. For example, GPS data that is not processed (e.g., analyzed and associated with a nearby landmark) is not particularly useful. Moreover, such unprocessed data may not be in a suitable format for use by other applications.

Therefore, the expression of, or useful organization of, the ephemeral data can be maintained within a data store having organized data structures, e.g., contextual data tags, that contain contextual data derived from the sensed or otherwise acquired ephemeral data, e.g., association between GPS data and a known landmark.

Additionally, the sensed or otherwise derived ephemeral data may be associated with a reference to the user's object(s), e.g., files, documents, destinations, etc., such as being associated with a user object event. For example, GPS, audio data, etc., may be converted, e.g., analyzed and/or formatted and thereafter associated, e.g., in time and/or location, with a user object event such as object creation, object editing, object transferring, etc. Thus, by way of example, collected ephemeral GPS data may be converted into contextual data by associating it with a known landmark and thereafter associating it with an object event, e.g., editing a document. Similarly, collected ephemeral audio data may be converted to contextual data by extracting keywords from audio and associating the keywords with an object event, e.g., emailing the object to a device contact.

Furthermore, these references or associations, e.g., between contextual data and objects, may be maintained locally (i.e., on-device) and/or in remotely accessible storage, e.g., in the cloud. In addition to using file, process, application and hardware connection events as triggers for collecting the ephemeral data, the collection can also occur at regular intervals or otherwise according to a policy. This permits, for example, the best of the ephemeral data collected by co-located devices to be shared and associated with references to content/user objects on each of the user's devices. This also allows for a busy user device to use the ephemeral data collected by another user device, e.g., a user device that is less-busy and co-located. Accordingly, a user device may control (e.g., throttle) its own ephemeral data collection, e.g., until the particular user device is less busy or otherwise has appropriate processing and/or memory.

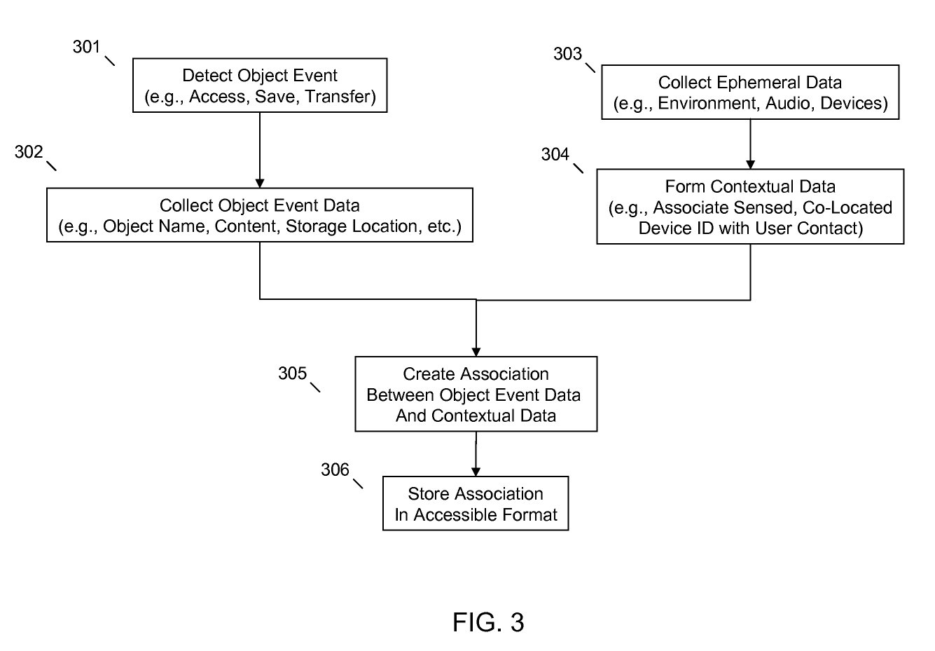

Referring to FIG. 3, an embodiment therefore detects an object event (e.g., accessing a user object, saving a user object, transferring a user object, etc.) at 301 and utilizes this as a trigger for collecting object event data at 302. The object event data collected at 302 may include but is not limited to a file name of the object, a storage location of the object, a type for the object (e.g., application type), as well as content of the object (e.g., key words).

Similarly, an embodiment may utilize the object event at 301 a trigger for collecting ephemeral data at 303, although the ephemeral data may be collected without use of such trigger, e.g., according to a timing policy. Nonetheless, the object event 301 may be utilized to associate the ephemeral data collected at 303 with the object which is the subject of the object event at 301. For example, sensor data collected from a plurality of sensors may be associated in time with the object for which the event takes place, e.g., at 301.

Given the availability of the ephemeral data collected at 303, an embodiment may convert the ephemeral data into a format usable by a searching application, e.g., convert the ephemeral data into contextual data terms. Ephemeral data is unstructured and there conventionally has been no easy way to find personal meaning or context in that ephemeral data.

Context may be comprised of ephemeral data gathered from a user device, e.g. sensors, hardware connections, etc. In addition, information gathered e.g. keywords, meta-data, etc. from user generated content/objects, may be stored as object event data by the user device(s). Facts gathered through current context are combined with user actions, calendar, email, etc., to form correlations or associations.

For example, as illustrated at 304, an embodiment may analyze the ephemeral data, e.g., GPS data, and convert it to contextual data. In this process, the ephemeral data may be converted to keywords or other searchable data. By way of example, raw ephemeral GPS coordinates may be converted into key words of a nearby location using map data. Similarly, a sensed, co-located user device, e.g., a friend or family member's smart phone detected via short range wireless or near field communication, may be associated with a device contact of the user device collecting the object event data. This information then may be collected, converted to a searchable form (e.g., text form of the location, text form of the device ID or contact name, etc.) and stored as contextual data at 304.

Having object event data and contextual data, an embodiment may thus associate the two at 305. In other words, at 305 an embodiment may create a reference or link between the contextual data, i.e., data derived from ephemeral data, and the object event data, i.e., data derived from with the object associated with the event. In this way, an embodiment may create a store of contextual data and object event data that is associated with a particular user object. This store may be formed at 306 for use in a variety of applications, e.g., answering user object search queries, as further described herein. This store may be compiled by various user devices and shared, e.g., via cloud account associations, and/or the contextual data and/or object event data may be stored locally on a single user device. Moreover, the store may be a distributed store, e.g., contextual data stored on one device, object event data stored another device, combinations of data stored on separate devices for sharing, or like arrangements. In this regard, for example, a user's devices may be grouped together. Other users may be grouped with a user, e.g., subject to an opt-in to such a group.

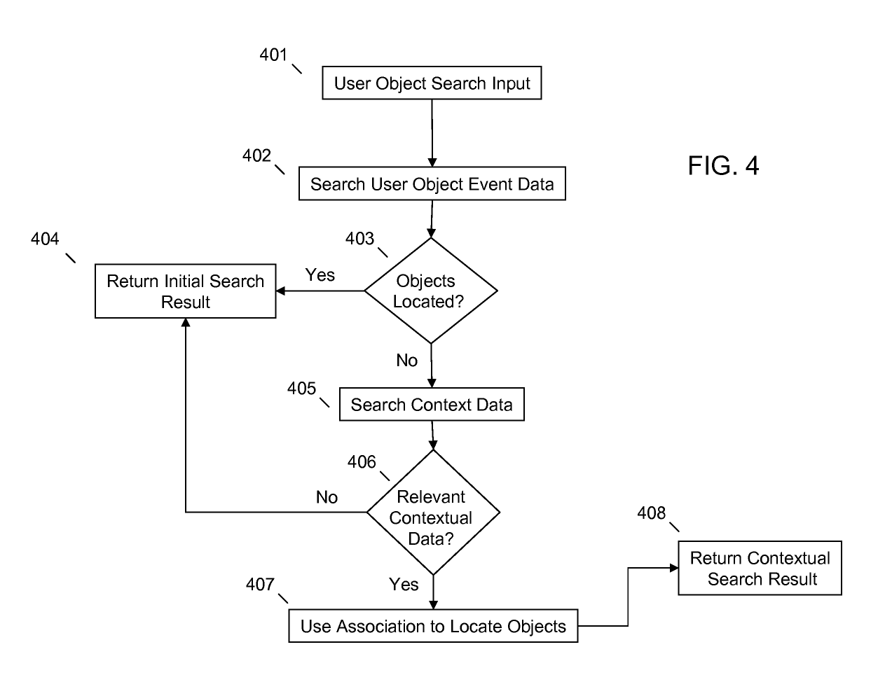

For a user application then, e.g., a user object searching application, the store of contextual data and object event data may be used to provide a more complete picture of the context surrounding various object events, including ephemeral data that is easy for the user to remember. By way of example, FIG. 4 illustrates an example of using contextual data in user object searching.

Therefore, at 401 a user may enter user object search input, e.g., key words and/or time limits, etc., into a user object searching application. The user object searching application may search the user object event data according to the user object search input. For example, an embodiment may search the object event data for objects having creation times matching the input, search for object types matching the input, search for objects having keywords matching the input, etc. If objects are located, as determined at 403, an initial set of search results may be returned at 404. However, if objects are not located and/or an amount of objects are located such that the results may not be responsive (e.g., too many or too few objects), an embodiment may refine the searching using the contextual data available.

For example, if a user is searching for a document that the user knows was edited at a particular location and in a general time frame, searching of object event data may yield too many or too few results. Or, if the user correctly remembered the place and time, but not the title, keywords, etc., the object event data search might not locate the correct document or locate too many documents. For example, a search of “Find the file I was editing last Thursday”, may not yield any results because the user was meetings all day Thursday and edited no documents. The user may have, however, edited documents on Tuesday. By expanding the timeframe, the results may contain a result for such a user.

Accordingly, an embodiment may search the contextual data at 405, e.g., including location data associated with the document, such that relevant contextual data may be identified, as determined at 406. For example, an embodiment may find a contextual search term, e.g., a location associated with the user object search input, at 406. If so, an embodiment may use the association between this location term in the contextual data store, e.g., in time, with the user object, e.g., the document edited at the location, in order to return results that have been refined (e.g., re-ordered, ranked differently) or improved/modified using the contextual searching. If no relevant contextual data is found at 406, an embodiment may nonetheless return the initial search results based on object event data.

It should be noted that the steps outlined in the figures, e.g., FIGS. 3 and 4, may be altered or modified. For example, two steps may have their orders reversed. Likewise, two steps may be consolidated or a step may be omitted entirely.

For example, an embodiment may first attempt to locate the user object that is the subject of the user object search input using the contextual data. This may be implemented as an adaptive learning process. For example, if a user's search history or profile indicated that the user routinely relies on (or similar users routinely rely on) contextual data for searching, an embodiment may first utilize a search of the contextual data. Moreover, if the contextual data and the object event data are merged, the separate searches may be consolidated to a single search. Likewise, the contextual data searching may be followed by object event data searching.

Accordingly, the embodiments described herein may leverage additional contextual data derived from ephemeral data in various applications, e.g., user object searching applications. As may be appreciated from the forgoing, this permits a larger amount of data to be used in conducting user object searches and permits a user to search using information that is particularly memorable but conventionally ephemeral, i.e., transient or otherwise not put to use.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. Any combination of one or more non-signal device readable storage medium(s) may be utilized. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
collecting, using a first user device, ephemeral data associated with a user object event;
collecting, using at least one processor, user object event data;
creating, using at least one processor, an association between the ephemeral data and the user object event data; and
storing, in a memory, the association in a data structure accessible to a device application.

2. The method of claim 1, wherein the user object event data is selected from the group of data consisting of user object creation event data, user object access event data, user object storage event data, user object transmission event data, and user object content data.

3. The method of claim 1, wherein the ephemeral data is selected from the group of data consisting of environmental data, biometric data, light data, audio data, device motion data, device orientation data, location data, hardware connection data, co-located device data, virtual connection data, device application data, and device state data.

4. The method of claim 1, wherein the ephemeral data associated with a user object event is collected using device sensors located on the first user device and a co-located user device.

5. The method of claim 1, wherein the memory is selected from the group of storage devices consisting of a local storage device of the first user device, a central storage device accessible to the first user device, and a distributed storage device accessible to the first user device.

6. The method of claim 1, further comprising converting the ephemeral data into contextual data;
wherein the converting comprises:
analyzing the ephemeral data; and
forming a searchable context data term based on the analyzing.

7. The method of claim 6, further comprising:
accepting, at an input component of the first user device, a user object search input;
searching the user object event data according to the user object search input;
searching searchable context data terms of the contextual data according to the user object search input; and
returning a search result.

8. The method of claim 6, further comprising:
accepting, at an input component of the first user device, the user object search input;
searching searchable context data terms of the contextual data according to the user object search input;
identifying a user object using the association between the contextual data and the user object event data; and
returning a search result.

9. The method of claim 8, wherein the user object search input includes only searchable context data terms.

10. The method of claim 9, further comprising converting the user object search input into object event data using the association.

11. An information handling device, comprising:
one or more sensors that collect ephemeral data;
a processor; and
a memory device that stores instructions executable by the processor to:
collect ephemeral data associated with a user object event;
collect user object event data;
create an association between the ephemeral data and the user object event data; and
store the association in a data structure accessible to a device application.

12. The information handling device of claim 11, wherein the user object event data is selected from the group of data consisting of user object creation event data, user object access event data, user object storage event data, user object transmission event data, and user object content data.

13. The information handling device of claim 11, wherein the ephemeral data is selected from the group of data consisting of environmental data, biometric data, light data, audio data, device motion data, device orientation data, location data, hardware connection data, co-located device data, virtual connection data, device application data, and device state data.

14. The information handling device of claim 11, wherein the ephemeral data associated with a user object event is collected using the one or more sensors the information handling device and a co-located user device.

15. The information handling device of claim 11, wherein the data structure is stored in a location selected from the group consisting of a local storage device of the information handling device, a central storage device accessible to the information handling device, and a distributed storage device accessible to the information handling device.

16. The information handling device of claim 11, wherein the instructions are further executable by the processor to convert the ephemeral data into contextual data;
wherein to convert comprises:
analyzing the ephemeral data; and
forming a searchable context data term based on the analyzing.

17. The information handling device of claim 16, wherein the instructions are further executable by the processor to:
accept, at an input component of the information handling device, a user object search input;
search the user object event data according to the user object search input;
search searchable context data terms of the contextual data according to the user object search input; and
return a search result.

18. The information handling device of claim 16, wherein the instructions are further executable by the processor to:
accept, at an input component of the information handling device, the user object search input;
search searchable context data terms of the contextual data according to the user object search input;
identify a user object using the association between the contextual data and the user object event data; and
return a search result.

19. The information handling device of claim 18, wherein the user object search input includes only searchable context data terms.

20. A product, comprising:
a storage device having code stored therewith, the code comprising:
code that collects, using a first user device, ephemeral data associated with a user object event;
code that collects, using at least one processor, user object event data;
code that creates, using at least one processor, an association between the ephemeral data and the user object event data; and
code that stores, in a memory, the association in a data structure accessible to a device application.
